(19) United States
(12) Patent Application Publication
(10) Pub. No.: US 2026/0292461 A1
(43) Pub. Date: Sep. 24, 2026

(54) FIRST RESPONDER COORDINATION SYSTEM AND METHOD FOR VEHICLE COLLISIONS

(71) Applicant: MOTIVE TECHNOLOGIES, INC., San Francisco, CA (US)

(72) Inventors: Avinash DEVULAPALLI, Benfaluru (IN); Gopal GUPTA, Magarpatta City (IN); Umair JAVED, Lahor (PK)

(21) Appl. No.: 19/086,587

(22) Filed: Mar. 21, 2025

(51) Int. Cl. H04W 4/90; G07C 5/00; H04W 4/029

(52) U.S. Cl. CPC H04W 4/90; G07C 5/008; H04W 4/029

(57) ABSTRACT

A system and method for nationwide emergency response coordination following vehicle collisions. The system receives emergency data from vehicle computing devices and intelligently routes communications to appropriate emergency services using a pool of temporary routing numbers. The system determines the vehicle's geographic location, accesses a database of emergency service coverage areas, and selects a local provider. It obtains a temporary routing number from a managed pool and establishes a priority connection to the selected provider. The system implements sophisticated number management including verification of active usage, expiration timestamps, and automated recycling. Emergency data is transmitted through prioritized channels with confirmation tracking. The system can operate in automatic mode or with fleet manager oversight, implementing timeout-based escalation when needed. This approach enables rapid, reliable emergency response while efficiently managing limited routing resources across a distributed emergency services network.

### BACKGROUND

Vehicle collisions require rapid emergency response to minimize casualties and damage. Traditional emergency response systems rely on manual reporting, typically through direct emergency (e.g., 911) calls from vehicle occupants, witnesses, or passing motorists. These manual reports can be delayed or inaccurate, particularly in severe collisions where vehicle occupants are incapacitated or in remote areas with few or no witnesses.

Even when collisions are promptly reported, emergency responders often lack critical information about the incident. Basic details such as precise location, vehicle type, number of occupants, or presence of hazardous materials may not be immediately available. This information gap can hamper response effectiveness and potentially endanger first responders who arrive at the scene without full situational awareness.

Commercial vehicle fleets face additional technical challenges in managing emergency response. Specifically, fleet operators need to coordinate with emergency services across wide geographic areas (versus local areas) while maintaining oversight of their vehicles and drivers. The delay between collision occurrence and fleet notification can impede effective response coordination and increase liability exposure.

Current systems typically handle collision detection and emergency notification as separate processes, leading to potential delays and information loss between detection and response. Additionally, these systems generally lack mechanisms for intelligent routing of emergency calls or context data sharing with first responders.

### BRIEF DESCRIPTION OF THE FIGURES

FIG. 1 is a block diagram illustrating a system for automated emergency response based on vehicle collision detection according to some of the disclosed embodiments.

FIG. 2 is a flow diagram illustrating a method for managing configurable emergency notifications following vehicle collision detection according to some of the disclosed embodiments.

FIG. 3 is a flow diagram illustrating a method for establishing and managing emergency service connections according to some of the disclosed embodiments.

FIG. 4 is a flow diagram illustrating a method for gathering and validating emergency response data according to some of the disclosed embodiments.

FIG. 5 is a block diagram of a computing device according to some embodiments of the disclosure.

### DETAILED DESCRIPTION

Traditional collision response systems, described above, suffer from technical limitations in data routing and emergency services integration. Specifically, the direct transmission of collision data to emergency services creates significant technical challenges in managing real-time data flow, network congestion, and communication protocol compatibility. These systems must simultaneously handle high-priority emergency data packets while maintaining connection quality and ensuring delivery confirmation. The technical complexity increases when dealing with multiple data sources that must be synchronized and validated before transmission to emergency services. Additionally, the routing of emergency calls across different jurisdictions requires complex telecommunications infrastructure to maintain dedicated emergency lines while preventing conflicts in temporary number assignment and management.

The disclosed system solves these technical problems through a multi-stage data processing and routing architecture. The system implements a packet prioritization scheme that separates collision data into multiple priority levels, enabling handling of critical data while managing network resources. A dynamic routing mechanism assigns and manages temporary emergency numbers through a pool allocation system, preventing routing conflicts while maintaining dedicated emergency lines. The system further employs a stateful data aggregation pipeline that synchronizes and validates multiple data streams before transmission, ensuring data consistency while minimizing latency. This technical architecture enables reliable emergency data transmission while efficiently managing network resources and maintaining connection quality through automated retry mechanisms and failover paths.

In some implementations, the techniques described herein relate to a system including: a vehicle computing device configured to record telemetry data generated by a vehicle during operation; a collision detection system configured to receive the telemetry data, determine that a collision involving the vehicle has occurred, generate emergency data representing the collision, and transmit the emergency data to a remote computing system, the remote computing system configured to: determine a geographic location of the vehicle; access an emergency services database storing coverage areas for multiple emergency service providers; select a local emergency service provider based on the geographic location; obtain a temporary routing number from a pool of emergency routing numbers; establish a priority connection to the local emergency service provider using the temporary routing number, the priority connection including one or both of a voice or data connection; transmit the emergency data via the priority connection; release the temporary routing number back to the pool after a predetermined time period; and log connection metrics and routing data.

In some implementations, the techniques described herein relate to a system, the remote computing system further configured to: check fleet preferences before establishing the priority connection; based on the fleet preferences, either proceed with one of an automatic connection or request manager approval; and implementing a timeout-based escalation if manager approval is not received within a threshold period.

In some implementations, the techniques described herein relate to a system, wherein establishing the priority connection includes: configuring quality of service parameters for emergency traffic; implementing packet prioritization protocols; and verifying connection quality meets emergency service requirements.

In some implementations, the techniques described herein relate to a system, wherein obtaining the temporary routing number includes: identifying available numbers in the pool; assigning an expiration timestamp to the available numbers; and updating a pool status.

In some implementations, the techniques described herein relate to a system, wherein selecting the local emergency service provider includes: determining jurisdictional boundaries from the coverage areas; evaluating current provider capacity and capabilities; checking for service outages or disruptions; and identifying backup providers if required.

In some implementations, the techniques described herein relate to a system, wherein transmitting the emergency data includes: generating a first data package containing vehicle location and collision severity data; generating a second data package containing vehicle occupant and hazardous material data; transmitting the first data package with high priority routing; transmitting the second data package; and maintaining connection state between package transmissions.

In some implementations, the techniques described herein relate to a system, the remote computing system further configured to: assign the temporary routing number an active status for a predetermined time window; monitor for additional emergency data during the predetermined time window; append any additional emergency data to an existing connection; and recycle the temporary routing number only after the predetermined time window expires or the call completes.

In some implementations, the techniques described herein relate to a method including: receiving emergency data indicating a vehicle requires emergency response; determining a geographic location of the vehicle; accessing an emergency services database storing coverage areas for multiple emergency service providers; selecting a local emergency service provider based on the geographic location; obtaining a temporary routing number from a pool of emergency routing numbers; establishing a priority connection to the local emergency service provider using the temporary routing number, the priority connection including one or both of a voice or data connection; transmitting the emergency data via the priority connection; releasing the temporary routing number back to the pool after a predetermined time period; and logging connection metrics and routing data.

In some implementations, the techniques described herein relate to a method, further including: checking fleet preferences before establishing the priority connection; based on the fleet preferences, either proceeding with one of an automatic connection or requesting manager approval; and implementing a timeout-based escalation if manager approval is not received within a threshold period.

In some implementations, the techniques described herein relate to a method, wherein establishing the priority connection includes: configuring quality of service parameters for emergency traffic; implementing packet prioritization protocols; and verifying connection quality meets emergency service requirements.

In some implementations, the techniques described herein relate to a method, wherein obtaining the temporary routing number includes: identifying available numbers in the pool; assigning an expiration timestamp to the available numbers; and updating a pool status.

In some implementations, the techniques described herein relate to a method, wherein selecting the local emergency service provider includes: determining jurisdictional boundaries from the coverage areas; evaluating current provider capacity and capabilities; checking for service outages or disruptions; and identifying backup providers if needed.

In some implementations, the techniques described herein relate to a method, wherein transmitting the emergency data includes: generating a first data package containing vehicle location and collision severity data; generating a second data package containing vehicle occupant and hazardous material data; transmitting the first data package with high priority routing; transmitting the second data package; and maintaining connection state between package transmissions.

In some implementations, the techniques described herein relate to a method, further including: assign the temporary routing number an active status for a predetermined time window; monitor for additional emergency data during the predetermined time window; append any additional emergency data to an existing connection; and recycle the temporary routing number only after the predetermined time window expires or the call completes.

In some implementations, the techniques described herein relate to a non-transitory computer-readable storage medium for tangibly storing computer program instructions capable of being executed by a computer processor, the computer program instructions defining steps of: receiving emergency data indicating a vehicle requires emergency response; determining a geographic location of the vehicle; accessing an emergency services database storing coverage areas for multiple emergency service providers; selecting a local emergency service provider based on the geographic location; obtaining a temporary routing number from a pool of emergency routing numbers; establishing a priority connection to the local emergency service provider using the temporary routing number, the priority connection including one or both of a voice or data connection; transmitting the emergency data via the priority connection; releasing the temporary routing number back to the pool after a predetermined time period; and logging connection metrics and routing data.

In some implementations, the techniques described herein relate to a non-transitory computer-readable storage medium, the steps further including: checking fleet preferences before establishing the priority connection; based on the fleet preferences, either proceeding with one of an automatic connection or requesting manager approval; and implementing a timeout-based escalation if manager approval is not received within a threshold period.

In some implementations, the techniques described herein relate to a non-transitory computer-readable storage medium, wherein establishing the priority connection includes: configuring quality of service parameters for emergency traffic; implementing packet prioritization protocols; and verifying connection quality meets emergency service requirements.

In some implementations, the techniques described herein relate to a non-transitory computer-readable storage medium, wherein obtaining the temporary routing number includes: identifying available numbers in the pool; assigning an expiration timestamp to the available numbers; and updating a pool status.

In some implementations, the techniques described herein relate to a non-transitory computer-readable storage medium, wherein selecting the local emergency service provider includes: determining jurisdictional boundaries from the coverage areas; evaluating current provider capacity and capabilities; checking for service outages or disruptions; and identifying backup providers if needed.

In some implementations, the techniques described herein relate to a non-transitory computer-readable storage medium, wherein transmitting the emergency data includes: generating a first data package containing vehicle location and collision severity data; generating a second data package containing vehicle occupant and hazardous material data; transmitting the first data package with high priority routing; transmitting the second data package; and maintaining connection state between package transmissions.

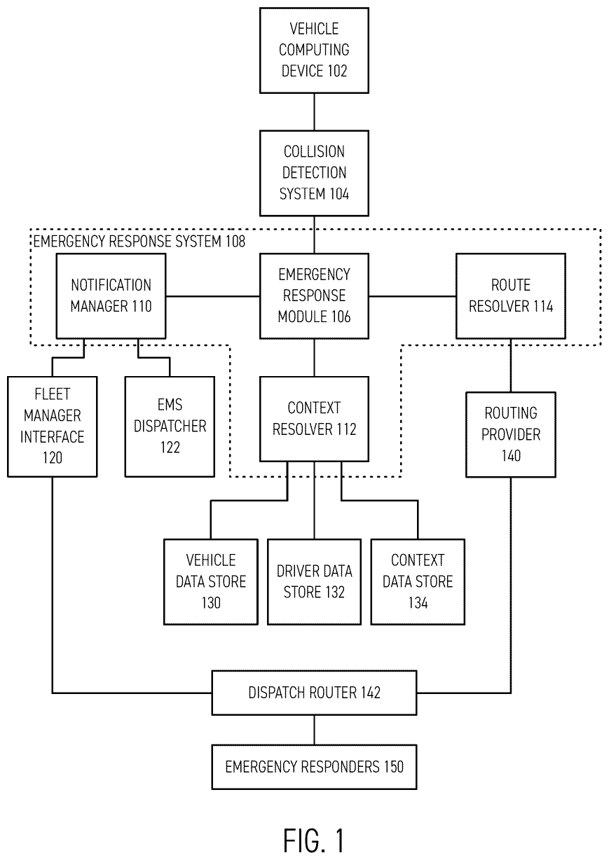

FIG. 1 is a block diagram illustrating a system for automated emergency response based on vehicle collision detection according to some of the disclosed embodiments.

In the illustrated embodiment, a vehicle computing device 102 is communicatively coupled to a collision detection system 104. The vehicle computing device 102 may comprise an onboard telemetry unit, vehicle gateway, dashcam or similar device (or combination thereof) capable of monitoring vehicle systems and transmitting data. In some implementations, the vehicle computing device 102 includes various interfaces to vehicle subsystems including, without limitation, the controller area network (CAN) bus, accelerometer modules, global positioning system (GPS) receivers, cameras, sensors, and cellular communication modules. The vehicle computing device 102 may continuously monitor and buffer vehicle telemetry data for processing by the collision detection system 104.

The collision detection system 104 monitors vehicle data to detect collision events and, upon detecting a severe collision, transmits collision data to an emergency response module 106. The collision detection system 104 may utilize various sensor inputs including, without limitation, accelerometer data, speed data, impact sensors, airbag deployment indicators, or vehicle diagnostic codes to identify severe collision events. In some implementations, the collision detection system 104 employs a multi-stage filtering approach that combines rule-based heuristics with machine learning models to accurately classify collision severity while minimizing false positives. In some implementations, the collision detection system 104 can be located within a vehicle. In other implementations, the collision detection system 104 can be implemented on a computing device remote to the vehicle computing device 102. In yet another implementation, the collision detection system 104 can be distributed with portions local to the vehicle and other portions local to a remote computing system.

The emergency response module 106 is a component of an emergency response system 108 that can coordinate automated emergency response activities. The emergency response system 108 may be implemented as a cloud-based service or distributed system capable of processing multiple simultaneous emergency events. As illustrated, the emergency response system 108 includes a notification manager 110, a context resolver 112, and a route resolver 114. These components work together to facilitate rapid and informed emergency response to vehicle collisions.

In some implementations, the notification manager 110 handles the dispatch of emergency notifications through one or more configurable paths. In a first path, the notification manager 110 routes collision alerts through a fleet manager interface 120, allowing fleet operators to confirm and coordinate emergency response. In a second path, the notification manager 110 can automatically route alerts directly to an emergency medical service (EMS) dispatcher 122, bypassing fleet confirmation when immediate response is required. The notification manager 110 may employ configurable rule sets to determine the appropriate notification path based on factors such as collision severity, time of day, geographic location, or fleet preferences. In some implementations, the notification manager 110 implements a timeout mechanism that can automatically escalate to direct EMS dispatch if fleet manager confirmation is not received within a configurable time window.

In some implementations, the context resolver 112 aggregates relevant emergency information from multiple data stores to provide situational awareness to emergency responders. As illustrated, the context resolver 112 queries a vehicle data store 130 to retrieve vehicle-specific information (e.g., make, model, VIN, vehicle dimensions, fuel type), a driver data store 132 to obtain operator information (e.g., identity, medical conditions, emergency contacts, licenses), and a context data store 134 to gather situational data (e.g., road conditions, hazardous cargo manifests, weather conditions). In some implementations, the system may include other types of data stores and the disclosure is not limited to only those illustrated and described herein.

The context resolver 112 may implement caching and pre-fetching mechanisms to minimize data retrieval latency during emergency events. In some implementations, the data stores may be implemented using distributed database technologies suitable for high volume/frequency querying and may be periodically synchronized with fleet management systems to maintain current information. The context resolver 112 may also implement fallback mechanisms to provide partial information if certain data stores are unavailable during an emergency event.

The route resolver 114 manages the technical aspects of connecting with appropriate emergency services. Upon receiving a collision alert, the route resolver 114 interfaces with a routing provider 140 to obtain a temporary contact number for the nearest emergency services dispatch. The routing provider 140 maintains a dynamic mapping of emergency service jurisdictions and can rapidly establish priority connections through a dispatch router 142. In some implementations, the routing provider 140 may comprise an emergency services API that manages temporary number assignment and call routing. The route resolver 114 may maintain persistent connections with the routing provider 140 to minimize connection establishment overhead. Additionally, the route resolver 114 may implement automatic retry mechanisms and failover logic to handle scenarios where the primary routing provider connection fails.

The dispatch router 142 serves as the final connection point for emergency notifications, receiving confirmed alerts either directly from the fleet manager interface 120 or through the automated EMS dispatch path. The dispatch router 142 can utilize priority queuing mechanisms to ensure emergency calls are connected with minimal latency. It then establishes communication with emergency responders 150, transmitting both the emergency alert and the context information assembled by the context resolver 112.

The fleet manager interface 120 may provide various interaction mechanisms including, without limitation, mobile applications, web interfaces, or automated calling systems to facilitate rapid response from fleet operators. The interface may display collision information and provide single-click confirmation to initiate emergency response. In some implementations, the fleet manager interface 120 may implement role-based access control to ensure only authorized personnel can confirm emergency dispatch. The interface may also provide real-time status updates about the emergency response progress and maintain an audit trail of all actions taken.

Although described in terms of in-vehicle or remote computing systems, the various features may be implemented in one or the other depending on the needs of the system. For example, in some implementations, the EMS functionality described in the remote system may be partially or fully implemented within in-vehicle computing devices.

The system described in FIG. 1 thus provides an automated, configurable, and context-aware emergency response capability that can significantly reduce response times while ensuring emergency responders have access to critical information about the collision scene. The system's dual-path notification approach provides flexibility while maintaining rapid response capability, and its context gathering ensures informed emergency response. The various components work together to create a robust and reliable emergency response system that can handle the complexities of real-world collision scenarios while maintaining high availability and fault tolerance.

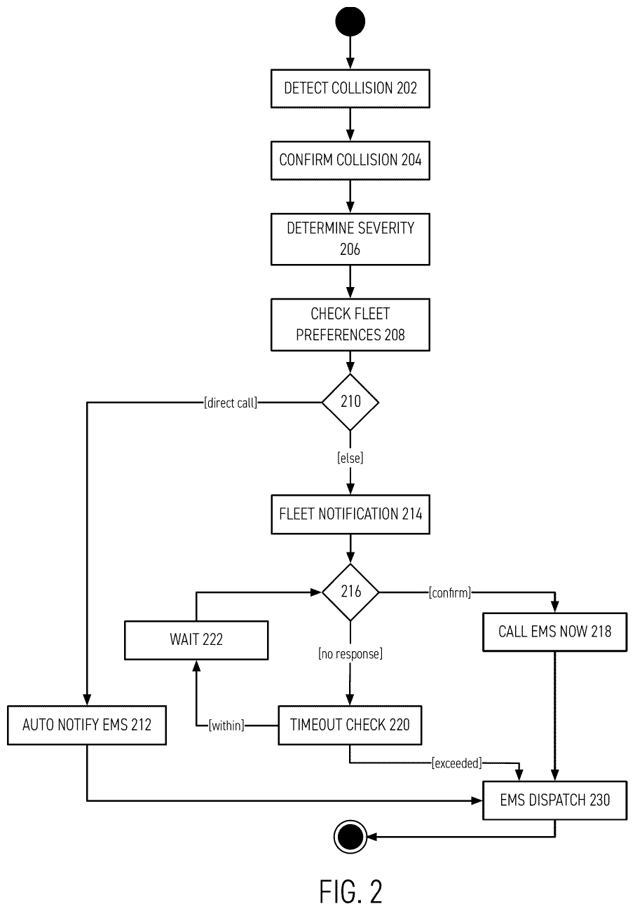

FIG. 2 is a flow diagram illustrating a method for managing configurable emergency notifications following vehicle collision detection according to some of the disclosed embodiments.

In step 202, the method begins when a collision event is detected.

In some implementations, this step may be triggered by receipt of collision data from a vehicle computing device or collision detection system as described previously with respect to FIG. 1. The collision event data may include, without limitation, accelerometer readings, impact sensor data, airbag deployment status, vehicle diagnostic codes, GPS coordinates, and timestamp information. In some implementations, the method may implement verification mechanisms to ensure the authenticity and integrity of received collision data before proceeding with emergency notification workflows.

In step 204, the method confirms that a collision has been detected through validation of the collision data.

In some implementations, this validation may include verifying that the collision data meets predetermined thresholds for factors including, without limitation, impact force, vehicle deceleration, airbag deployment status, or vehicle damage indicators. In some implementations, the validation process may employ multiple detection algorithms running in parallel to improve accuracy and reduce false positives. These algorithms may analyze different aspects of the collision data, such as impact patterns, vehicle motion signatures, and structural deformation indicators.

In step 206, the method determines the severity level of the confirmed collision.

In some implementations, the severity determination may utilize a multi-factor analysis incorporating various data points including, without limitation, impact force measurements, vehicle rollover indicators, cabin intrusion data, or multiple impact detection. In some implementations, the method may employ a weighted scoring system that considers the relative importance of different factors in assessing collision severity. In some implementations, the severity classification may include multiple tiers (e.g., low, medium, high, etc.) with configurable threshold values that can be adjusted based on historical emergency response data and outcomes. In some implementations, the severity level can be determined, confirmed, or augmented using a manual review process. In this implementation, a team of editors can manually review data points to assign severity levels (e.g., life-threatening collisions, etc.).

In step 208, after confirming high severity, the method checks the emergency notification preferences configured for the fleet associated with the vehicle involved in the collision.

In some implementations, these preferences may be stored in a fleet management database or similar data store and may include rule sets for different scenarios. In some implementations, preferences may be configured at multiple levels including global fleet settings, vehicle group settings, individual vehicle settings, and time-based or location-based rules. The method may implement a hierarchical evaluation of these preferences to determine the appropriate notification workflow.

In step 210, the method evaluates whether the fleet preferences indicate direct emergency calling should be used.

In some implementations, this decision represents a branching in the notification workflow. The direct calling preference may be influenced by multiple factors including time of day, vehicle location, cargo type, and historical response patterns. In some implementations, the method may also consider real-time factors such as cellular signal strength or emergency services availability in making this determination.

If direct calling is enabled, the method proceeds to step 212, where it initiates automatic EMS notification. This step includes a series of operations to establish emergency services contact, including gathering relevant collision and vehicle data, obtaining a temporary emergency services number through the routing provider as described with respect to FIG. 1, and initiating the emergency call. The method may implement parallel processing to prepare context data while establishing the emergency connection to minimize overall response time.

If direct calling is not enabled, the method proceeds to step 214 to issue a fleet notification. The notification delivery system may employ multiple redundant channels including, without limitation, mobile push notifications, SMS messages, email alerts, or automated voice calls to designated fleet personnel. Each notification includes collision details and provides mechanisms for rapid response. The method may implement retry logic and escalation procedures if initial notification attempts fail.

In step 216, the method monitors for a fleet response to the notification.

In some implementations, the method implements authentication mechanisms to verify that responses come from authorized personnel, while also monitoring multiple response channels simultaneously to ensure no legitimate responses are missed. The response monitoring system may adapt its polling frequency based on the collision severity and time elapsed since notification.

If fleet personnel confirm the emergency, the method proceeds to step 218 where it initiates the emergency call. This step mirrors the automatic notification process of step 212 but includes additional context about the fleet manager's confirmation. In some implementations, the method may append any additional information provided by fleet personnel during the confirmation process to the emergency services data package. Additionally, the method may maintain the temporary number's active status during its time window to allow appending of any additional emergency data that becomes available. For example, if updated vehicle telemetry, new hazard information, or additional occupant data is received while the temporary number is still active, this data can be dynamically appended to the existing emergency connection without requiring a new number assignment. This approach maximizes the utility of each temporary number while ensuring all available emergency information reaches responders through a single coordinated channel.

If no immediate fleet response is received, the method proceeds to step 220 to evaluate timeout status. In some implementations, the timeout monitoring system implements dynamic thresholds that may vary based on factors including collision severity, time of day, or historical fleet response patterns. In some implementations, the timeout thresholds may be automatically adjusted based on machine learning analysis of historical response data to optimize emergency response times while minimizing unnecessary escalations.

If the timeout threshold has been exceeded, the method proceeds to step 212 to initiate automatic EMS notification as described previously. This automated escalation ensures that high-severity collisions receive emergency response even in the absence of fleet confirmation. The method may include additional context information about the timeout escalation when contacting emergency services.

If the timeout threshold has not been exceeded, the method proceeds to step 222 where it implements a wait period before rechecking for fleet response. In some implementations, the wait period duration may be dynamically adjusted based on multiple factors including collision severity, time of day, or the number of previous notification attempts. In some implementations, during this wait period, the method may issue additional notifications through alternative channels or prepare backup notification pathways.

After the wait period in step 222, the method returns to step 216 to recheck for fleet response, creating a monitoring loop that continues until either confirmation is received or the timeout threshold is exceeded. This loop implements state management to track the number and type of notification attempts, responses received, and time elapsed.

Both the automatic notification path (step 212) and the fleet-confirmed notification path (step 218) converge at step 230, EMS dispatch. This step includes establishing connection with emergency services, transmitting relevant collision and vehicle data, and confirming successful dispatch of emergency responders. The method implements different data transmission protocols based on the capabilities of the local emergency services system and may include fallback mechanisms for scenarios where primary communication channels fail.

Throughout the entire workflow, the method can maintain detailed audit logs of all actions, decisions, and timestamps. These logs include metadata about each step in the process, enabling subsequent analysis and optimization of the notification workflows. The logging system implements secure storage and tamper-evident mechanisms to ensure the integrity of the audit trail.

The method illustrated in FIG. 2 thus provides a robust and flexible approach to emergency notification that balances the desire for fleet oversight with the need for rapid emergency response in high-severity collisions. The method implements multiple safeguards, including timeout-based escalation, to ensure emergency response is not unduly delayed while still respecting fleet preferences when practical. The monitoring and validation systems throughout the workflow ensure reliable operation while maintaining the flexibility to handle diverse real-world scenarios.

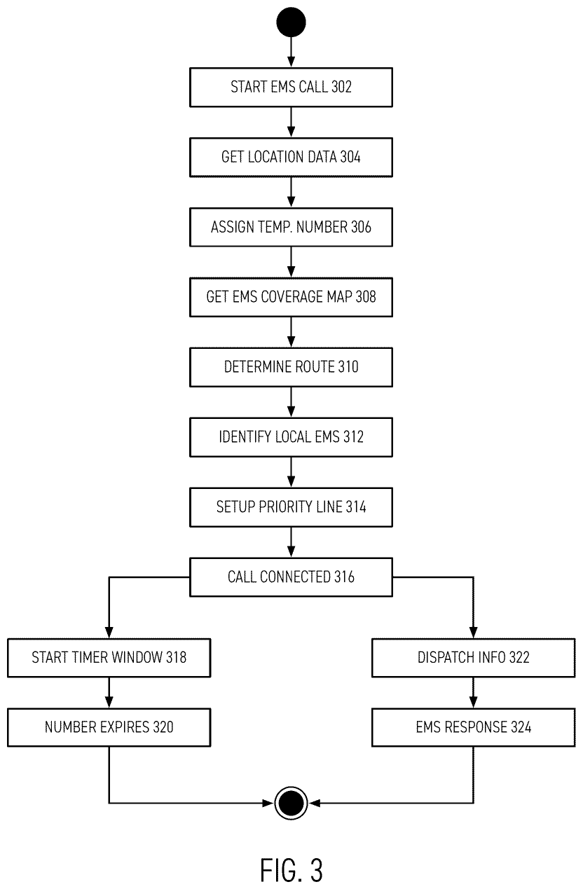

FIG. 3 is a flow diagram illustrating a method for establishing and managing emergency service connections according to some of the disclosed embodiments.

In step 302, the method begins the EMS call process following a confirmed collision event requiring emergency response.

In some implementations, this step may be triggered by either automatic notification or fleet manager confirmation as described previously with respect to FIG. 2. In some implementations, the method initializes tracking metrics including start time, collision severity level, and call priority status to ensure proper handling throughout the connection process.

In step 304, the method retrieves precise location data for the collision event.

In some implementations, this location data may include primary GPS coordinates from the vehicle's telemetry system as well as secondary location indicators such as cellular tower triangulation or last known vehicle route data. In some implementations, the method may implement filtering algorithms to validate GPS accuracy and resolve any discrepancies between multiple location sources. In scenarios where real-time GPS data is unavailable, the method may use predictive algorithms to estimate the vehicle's likely location based on its last known position and trajectory. In some implementations, the raw location reported via telemetry data may be refined by a remote computing system. For example, a latitude/longitude may be converted to a true position.

In step 306, the method assigns a temporary contact number for emergency services routing.

In some implementations, this temporary number is drawn from a pool of pre-allocated emergency routing numbers managed by a routing service. The assignment process includes validation checks to ensure the selected number is currently available and is not in use for other emergency calls. The temporary number serves as a unique identifier for the emergency event and enables priority routing through the emergency services network.

In step 308, the method retrieves current emergency services coverage mapping data.

In some implementations, this step involves querying a dynamic database of emergency service jurisdictions, including primary and backup service areas, current staffing levels, and specialized response capabilities. In some implementations, the coverage mapping system may account for factors such as municipal boundaries, service level agreements, and mutual aid arrangements between jurisdictions. In some implementations, the method may also consider real-time factors such as current emergency service load balancing and temporary service disruptions.

In step 310, the method performs route determination to identify the optimal emergency services connection path.

In some implementations, the routing algorithm considers multiple factors including physical proximity, jurisdiction boundaries, current emergency service capacity, and specialized response requirements (e.g., hazmat capabilities). In some implementations, the method may calculate multiple potential routing paths and assign priority scores based on weighted criteria such as estimated response time, service capabilities, and current availability.

In step 312, the method identifies the specific local emergency services dispatch center that will handle the emergency response. In some implementations, this step includes verification that the selected dispatch center is currently operational and capable of receiving emergency calls. The method may implement fallback logic to select alternate dispatch centers if the primary center is unavailable or experiencing technical difficulties.

In step 314, the method establishes a priority line connection to the selected emergency services dispatch center. In some implementations, this involves signaling to telecommunications providers that the call requires priority handling through emergency systems. In some implementations, the method may implement multiple connection protocols to ensure compatibility with various emergency service communication systems. Priority line setup includes mechanisms to preempt non-emergency traffic and ensure minimal connection latency.

In step 316, the method confirms successful establishment of the emergency services connection. In some implementations, this includes verification of both voice and data channel availability for transmitting collision information. In some implementations, the method implements connection quality monitoring to detect any degradation or interruption in the emergency services link. In some implementations, the method may establish redundant communication paths to ensure reliable information delivery.

In step 318, the method initiates a timer window for the temporary routing number. In some implementations, this timer ensures that emergency routing numbers are properly recycled and remain available for future emergency calls. In some implementations, the method implements state tracking to manage the lifecycle of temporary numbers and prevent any conflicts or premature recycling. In some implementations, the timer duration may be dynamically adjusted based on factors such as call complexity and emergency service protocols.

In step 320, the temporary routing number expires after the predetermined time window. In some implementations, the expiration process includes cleanup operations to ensure the number is properly released back to the available pool and all associated call routing data is archived. In some implementations, the method may implement grace periods or extension mechanisms for scenarios where additional connection time is required. In some implementations, obtaining a temporary routing number involves pool management operations. The method first identifies currently available numbers by querying the pool's status database, which maintains real-time tracking of number states including available, active, and cooldown periods. For each potentially available number, in some optional implementations, the method verifies recent usage history to prevent reassignment of numbers that may have residual connections or cached routing data in emergency service systems. This verification includes checking both successful and failed connection attempts associated with each number within a configurable lookback period. Once a suitable number is identified, the method assigns an expiration timestamp that determines both the initial active window and subsequent cooldown period. The pool status database is then atomically updated to reflect the new assignment, including the number's current state, assigned emergency event identifier, timestamp metadata, and scheduled recycling time. This pool management approach ensures reliable routing while preventing number conflicts that could impact emergency service connections.

Concurrent with the timer management, in step 322, the method transmits dispatch information to emergency services. In some implementations, this information package includes, without limitation, vehicle details, collision specifics, occupant data, and any hazardous material indicators. In some implementations, the method implements data formatting to ensure compatibility with various emergency service systems while maintaining data integrity. In some implementations, the method may segment data transmission based on priority levels to ensure critical information is delivered first.

In step 324, the method confirms receipt of emergency response initiation from the dispatch center. In some implementations, this confirmation may include details such as estimated arrival time, specific resources being deployed, and any special instructions for vehicle occupants. In some implementations, the method maintains an active communication channel to receive updates and additional instructions from emergency services. In some implementations, the method may also facilitate direct communication between emergency responders and fleet management personnel if needed.

Throughout the entire connection process, the method can include error handling and recovery mechanisms. For example, if connection quality degrades during the call, the method may automatically attempt to establish alternate communication paths. Similarly, if data transmission fails, the method implements retry logic with exponential backoff to avoid overwhelming emergency systems.

In some implementations, the method also maintains detailed logs of all communication events, including connection timestamps, data transmission records, and emergency service responses. These logs are crucial for subsequent analysis and optimization of the emergency response process. In some implementations, the logging system may implement secure storage and encryption to protect sensitive emergency response data.

The method illustrated in FIG. 3 thus provides a robust and reliable approach to establishing emergency service connections while ensuring collision information reaches first responders. The method's routing and connection management capabilities help minimize response times while maintaining high reliability. The various verification and monitoring mechanisms throughout the process help ensure successful emergency response coordination even in challenging scenarios.

In some implementations, the method may include additional features not explicitly shown in FIG. 3, such as automated status updates to fleet management systems or integration with vehicle telemetry for continuous situation monitoring. The method may also implement various optimization algorithms to continuously improve routing decisions based on historical emergency response data.

In some implementations, the method's communication management system includes protocol handling to ensure compatibility with diverse emergency service systems. For example, when establishing the priority line connection in step 314, the method may implement multiple telecommunication standards including, without limitation, E911 protocols, Voice over Internet Protocol (VoIP) emergency services, and traditional public-switched telephone network (PSTN) emergency routing.

The method implements protocol handling to ensure compatibility with diverse emergency service systems. When establishing the priority line connection in step 314, the method may implement multiple telecommunication standards including E911 protocols, VoIP emergency services, and traditional PSTN emergency routing. The priority line setup process includes negotiation of Quality of Service (QoS) parameters to ensure call clarity, implementation of packet prioritization for VoIP-based systems, establishment of redundant data channels for critical information, configuration of failover routing paths, and setup of secure communication tunnels for sensitive data.

In some implementations, the connection confirmation process in step 316 implements verification including two-way audio channel testing, data transmission capability verification, latency measurements to ensure acceptable response times, signal strength monitoring for wireless connections, and verification of emergency service system readiness. The method continuously monitors connection quality throughout the emergency call to detect any degradation or potential failures.

In some implementations, the timer management system implemented in step 318 and step 320 can include state tracking mechanisms. The system maintains detailed metadata about each temporary number including initial assignment timestamp, current usage status, associated collision event identifier, routing path configuration, connection quality metrics, and number recycling status. This metadata enables management of the temporary number pool while preventing conflicts or premature recycling of active numbers. In some implementations, step 320 can alternatively be executed immediately when data transmission is complete. In some implementations, the method can employ both techniques and can return a number to the pool when either data transmission terminates or a timer expires, whichever occurs sooner.

In some implementations, the information dispatch process in step 322 implements a multi-phase transmission protocol. The initial high-priority data burst contains precise collision coordinates, vehicle identification details, immediate hazard indicators, and occupant count and status. This is followed by a secondary data transmission including detailed vehicle telemetry, collision force vectors, structural damage assessments, and environmental conditions. Finally, a supplementary information package containing vehicle cargo manifests, hazardous material details, driver medical history, and fleet contact information is transmitted.

In some implementations, the method implements retry logic for failed transmissions, with different strategies based on the criticality of the information. Critical data transmission attempts use aggressive retry with minimal backoff periods, while secondary data implements exponential backoff to prevent network congestion. Supplementary data transmission uses gradual retry with longer intervals to ensure eventual delivery while minimizing system load.

In some implementations, the response confirmation process in step 324 includes multiple verification stages starting with initial acknowledgment of received information, followed by confirmation of emergency resource allocation. The method then processes transmission of estimated response times and receipt of specific response unit identifiers before final verification of responder route planning. This staged approach ensures all critical response elements are properly coordinated.

In some implementations, throughout the entire process, the method maintains detailed telemetry about the emergency connection including connection establishment times, data transmission rates, packet loss statistics, audio quality metrics, and system response latencies. This telemetry data is used for both real-time monitoring and subsequent analysis to optimize future emergency connections. The method implements analytics to identify patterns and potential improvements in the routing and connection process.

In some implementations, the logging system maintains secure, tamper-evident records of all operations including connection attempt timestamps, routing decisions and rationale, data transmission records, emergency service responses, system performance metrics, and error conditions and recovery actions. These logs are crucial for subsequent analysis, compliance verification, and continuous system improvement. The logging system implements secure storage with encryption and digital signatures to ensure data integrity.

The method illustrated in FIG. 3 thus provides an approach to establishing emergency service connections while ensuring collision information reaches first responders. The routing and connection management capabilities help minimize response times while maintaining high reliability, and the various verification and monitoring mechanisms throughout the process help ensure successful emergency response coordination even in challenging scenarios. The multiple layers of verification, monitoring, and error recovery provide the robustness needed for mission-critical emergency response systems.

The method illustrated in FIG. 3 thus provides an approach to establishing emergency service connections while ensuring critical collision information reaches first responders. The routing and connection management capabilities help minimize response times while maintaining high reliability, and the various verification and monitoring mechanisms throughout the process help ensure successful emergency response coordination even in challenging scenarios.

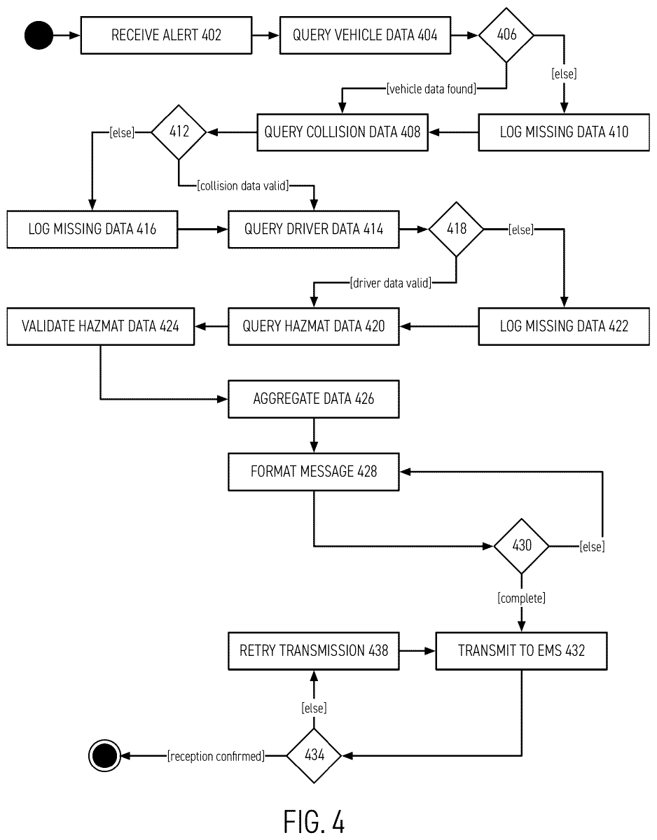

FIG. 4 is a flow diagram illustrating a method for gathering and validating emergency response data according to some of the disclosed embodiments.

In step 402, the method begins when an emergency alert is received. In some implementations, this alert may be generated by either automatic collision detection or fleet manager confirmation as described previously with respect to FIG. 2. The method initializes data gathering systems and establishes secure connections to various data stores that will be queried during the information collection process.

In step 404, the method queries available vehicle data stores to retrieve vehicle information. In some implementations, the query process may access multiple databases including fleet management systems, vehicle registration databases, and real-time telemetry systems. In some implementations, the method implements caching mechanisms to minimize query latency while ensuring data freshness. Query parameters may include vehicle identification number, fleet identifiers, and operational status indicators.

In step 406, the method determines whether the required vehicle data was successfully retrieved. In some implementations, this validation step includes verification of data completeness and consistency across multiple sources. In some implementations, the method may implement a scoring system to evaluate the quality and reliability of retrieved vehicle data. If valid vehicle data is found, the method proceeds to step 408. If vehicle data is not found or is incomplete, the method proceeds to step 410.

In step 410, the method logs the missing vehicle data condition in a secure audit system. In some implementations, the logging process includes detailed information about which specific data elements were missing or invalid, timestamps of query attempts, and system state information that may help diagnose the cause of the data gap. After logging the missing data condition, the method proceeds to step 408 to continue the data gathering process.

In step 408, the method queries collision data systems to retrieve detailed information about the emergency event. In some implementations, these queries may access real-time vehicle telemetry systems, impact sensor data stores, and automated crash notification systems. In some implementations, the method implements parallel query processing to minimize overall data retrieval time while maintaining data consistency.

In step 412, the method validates the retrieved collision data. In some implementations, the validation process includes verification of data timestamps, consistency checking across multiple sensor inputs, and correlation with vehicle telemetry data. If the collision data is valid, the method proceeds to step 414. If validation fails, the method proceeds to step 416 for error logging (similar to that described in connection with step 410).

In step 414, the method queries driver information systems to retrieve operator details. In some implementations, these queries may access multiple data sources including fleet personnel databases, commercial driver license systems, and medical information systems where available. In some implementations, the method implements strict access controls and data privacy mechanisms when handling sensitive driver information.

In step 418, the method verifies the completeness of retrieved driver data. This verification includes checking for required identification details, license status, and any relevant medical conditions. If driver data is complete, the method proceeds to step 420. If driver data is missing or incomplete, the method proceeds to step 422 for error logging (similar to that described in connection with step 410).

In step 420, the method queries hazardous materials databases to identify any dangerous cargo or special handling requirements. In some implementations, these queries may access vehicle manifest systems, dangerous goods databases, and special cargo registries. In some implementations, the method implements specialized formatting for hazardous materials data to ensure clear communication of dangers to emergency responders.

In step 424, the method validates the hazardous materials data retrieval results. If hazmat data is found, it is included in the emergency data package. If no hazmat data is found, the method records this negative result and proceeds. In either case, the method continues to step 426, as hazmat data may not be relevant for all vehicles.

In step 426, the method aggregates all retrieved data into a consolidated emergency information package. In some implementations, the aggregation process implements data normalization to ensure consistent formatting across different data sources. In some implementations, the method may also implement data prioritization to ensure critical information is positioned prominently in the consolidated package.

In step 428, the method formats the aggregated data according to emergency services communication protocols. In some implementations, the formatting process may implement multiple protocol standards to ensure compatibility with various emergency response systems. In some implementations, the method includes metadata about data freshness and confidence levels for each included data element.

In step 430, the method performs a final validation of the formatted data package. In some implementations, this validation includes verification of required fields, format compliance, and data consistency. If the data package is complete, the method proceeds to step 432. If validation fails, the method returns to step 426 for reaggregation with updated data.

In step 432, the method transmits the formatted data package to emergency services systems. In some implementations, the transmission process implements secure communication protocols and may include redundant transmission paths for critical data. In some implementations, the method maintains detailed transmission logs including timestamps and delivery confirmation attempts.

In step 434, the method verifies successful reception of the data package by emergency services systems. If reception is confirmed, the method proceeds may terminate. If reception confirmation fails, the method proceeds to step 438 for retry processing.

In step 438, the method implements retry logic for failed transmissions. In some implementations, the retry process includes exponential backoff timing while maintaining priority status for emergency data. In some implementations, the method may attempt alternate transmission paths or reformatting of data if initial attempts fail. After implementing retry logic, the method returns to step 432 for another transmission attempt.

After terminating, the method may perform post-operation cleanup. In some implementations, the cleanup step includes finalizing all audit logs, updating system status indicators, and preparing for subsequent data update cycles if needed. In some implementations, the method maintains state information about transmitted data to enable updates if additional information becomes available.

Throughout the entire process, the method can include error handling and recovery mechanisms. Each step includes timeout monitoring, error logging, and failure recovery procedures. The method implements state tracking to ensure that partial failures do not prevent the transmission of available emergency information.

The method illustrated in FIG. 4 thus provides a robust and reliable approach to gathering and validating emergency response data while ensuring critical information reaches first responders quickly and accurately. The various validation and error recovery mechanisms throughout the process help ensure successful emergency response coordination even when some data sources are unavailable or incomplete.

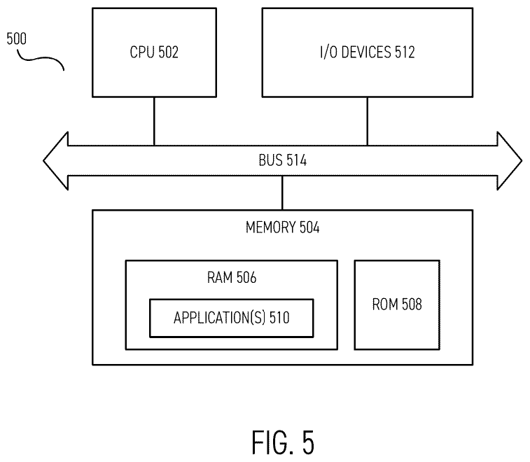

FIG. 5 is a block diagram of a computing device according to some embodiments of the disclosure.

As illustrated, the device 500 includes a processor or central processing unit (CPU) such as CPU 502 in communication with a memory 504 via a bus 514. The device also includes one or more input/output (I/O) or peripheral devices 512. Examples of peripheral devices include, but are not limited to, network interfaces, audio interfaces, display devices, keypads, mice, keyboard, touch screens, illuminators, haptic interfaces, global positioning system (GPS) receivers, cameras, or other optical, thermal, or electromagnetic sensors.

In some embodiments, the CPU 502 may comprise a general-purpose CPU. The CPU 502 may comprise a single-core or multiple-core CPU. The CPU 502 may comprise a system-on-a-chip (SoC) or a similar embedded system. In some embodiments, a graphics processing unit (GPU) may be used in place of, or in combination with, a CPU 502. Memory 504 may comprise a memory system including a dynamic random-access memory (DRAM), static random-access memory (SRAM), Flash (e.g., NAND Flash), or combinations thereof. In one embodiment, the bus 514 may comprise a Peripheral Component Interconnect Express (PCIe) bus. In some embodiments, the bus 514 may comprise multiple busses instead of a single bus.

Memory 504 illustrates an example of a non-transitory computer storage media for the storage of information such as computer-readable instructions, data structures, program modules, or other data. Memory 504 can store a basic input/output system (BIOS) in read-only memory (ROM), such as ROM 508 for controlling the low-level operation of the device. The memory can also store an operating system in random-access memory (RAM) for controlling the operation of the device.

Applications 510 may include computer-executable instructions which, when executed by the device, perform any of the methods (or portions of the methods) described previously in the description of the preceding figures. In some embodiments, the software or programs implementing the method embodiments can be read from a hard disk drive (not illustrated) and temporarily stored in RAM 506 by CPU 502. CPU 502 may then read the software or data from RAM 506, process them, and store them in RAM 506 again.

The device may optionally communicate with a base station (not shown) or directly with another computing device. One or more network interfaces in peripheral devices 512 are sometimes referred to as a transceiver, transceiving device, or network interface card (NIC).

An audio interface in peripheral devices 512 produces and receives audio signals such as the sound of a human voice. For example, an audio interface may be coupled to a speaker and microphone (not shown) to enable telecommunication with others or generate an audio acknowledgment for some action. Displays in peripheral devices 512 may comprise liquid crystal display (LCD), gas plasma, light-emitting diode (LED), or any other type of display device used with a computing device. A display may also include a touch-sensitive screen arranged to receive input from an object such as a stylus or a digit from a human hand.

A keypad in peripheral devices 512 may comprise any input device arranged to receive input from a user. An illuminator in peripheral devices 512 may provide a status indication or provide light. The device can also comprise an input/output interface in peripheral devices 512 for communication with external devices, using communication technologies, such as USB, infrared, Bluetooth®, or the like. A haptic interface in peripheral devices 512 provides tactile feedback to a user of the client device.

A GPS receiver in peripheral devices 512 can determine the physical coordinates of the device on the surface of the Earth, which typically outputs a location as latitude and longitude values. A GPS receiver can also employ other geo-positioning mechanisms, including, but not limited to, triangulation, assisted GPS (AGPS), E-OTD, CI, SAI, ETA, BSS, or the like, to further determine the physical location of the device on the surface of the Earth. In one embodiment, however, the device may communicate through other components, providing other information that may be employed to determine the physical location of the device, including, for example, a media access control (MAC) address, Internet Protocol (IP) address, or the like.

The device may include more or fewer components than those shown, depending on the deployment or usage of the device. For example, a server computing device, such as a rack-mounted server, may not include audio interfaces, displays, keypads, illuminators, haptic interfaces, Global Positioning System (GPS) receivers, or cameras/sensors. Some devices may include additional components not shown, such as graphics processing unit (GPU) devices, cryptographic co-processors, artificial intelligence (AI) accelerators, or other peripheral devices.

The subject matter disclosed above may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware, or any combination thereof (other than software per se). The preceding detailed description is, therefore, not intended to be taken in a limiting sense.

Throughout the specification and claims, terms may have nuanced meanings suggested or implied in context beyond an explicitly stated meaning. Likewise, the phrase “in an embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and,” “or,” or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general-purpose computer to alter its function as detailed herein, a special purpose computer, application-specific integrated circuit (ASIC), or other programmable data processing apparatus, such that the instructions, which execute via the processor of the computer or other programmable data processing apparatus, implement the functions/acts specified in the block diagrams or operational block or blocks. In some alternate implementations, the functions or acts noted in the blocks can occur out of the order noted in the operational illustrations. For example, two blocks shown in succession can in fact be executed substantially concurrently or the blocks can sometimes be executed in the reverse order, depending upon the functionality or acts involved.

We claim:

1. A system comprising:
a vehicle computing device configured to record telemetry data generated by a vehicle during operation;
a collision detection system configured to receive the telemetry data, determine that a collision involving the vehicle has occurred, generate emergency data representing the collision, and transmit the emergency data to a remote computing system, the remote computing system configured to:
determine a geographic location of the vehicle;
access an emergency services database storing coverage areas for multiple emergency service providers;
select a local emergency service provider based on the geographic location;
obtain a temporary routing number from a pool of emergency routing numbers;
establish a priority connection to the local emergency service provider using the temporary routing number, the priority connection comprising one or both of a voice or data connection;
transmit the emergency data via the priority connection;
release the temporary routing number back to the pool after a predetermined time period; and
log connection metrics and routing data.

2. The system of claim 1, the remote computing system further configured to:
check fleet preferences before establishing the priority connection;
based on the fleet preferences, either proceed with one of an automatic connection or request manager approval; and
implementing a timeout-based escalation if manager approval is not received within a threshold period.

3. The system of claim 1, wherein establishing the priority connection comprises:
configuring quality of service parameters for emergency traffic;
implementing packet prioritization protocols; and
verifying connection quality meets emergency service requirements.

4. The system of claim 1, wherein obtaining the temporary routing number comprises:
identifying available numbers in the pool;
assigning an expiration timestamp to the available numbers; and
updating a pool status.

5. The system of claim 1, wherein selecting the local emergency service provider comprises:
determining jurisdictional boundaries from the coverage areas;
evaluating current provider capacity and capabilities;
checking for service outages or disruptions; and
identifying backup providers if required.

6. The system of claim 1, wherein transmitting the emergency data comprises:
generating a first data package containing vehicle location and collision severity data;
generating a second data package containing vehicle occupant and hazardous material data;
transmitting the first data package with high priority routing;
transmitting the second data package; and
maintaining connection state between package transmissions.

7. The system of claim 1, the remote computing system further configured to:
assign the temporary routing number an active status for a predetermined time window;
monitor for additional emergency data during the predetermined time window;
append any additional emergency data to an existing connection; and
recycle the temporary routing number only after the predetermined time window expires or the call completes.

8. A method comprising:
receiving emergency data indicating a vehicle requires emergency response;
determining a geographic location of the vehicle;
accessing an emergency services database storing coverage areas for multiple emergency service providers;
selecting a local emergency service provider based on the geographic location;
obtaining a temporary routing number from a pool of emergency routing numbers;
establishing a priority connection to the local emergency service provider using the temporary routing number, the priority connection comprising one or both of a voice or data connection;
transmitting the emergency data via the priority connection;
releasing the temporary routing number back to the pool after a predetermined time period; and
logging connection metrics and routing data.

9. The method of claim 8, further comprising:
checking fleet preferences before establishing the priority connection;
based on the fleet preferences, either proceeding with one of an automatic connection or requesting manager approval; and
implementing a timeout-based escalation if manager approval is not received within a threshold period.

10. The method of claim 8, wherein establishing the priority connection comprises:
configuring quality of service parameters for emergency traffic;
implementing packet prioritization protocols; and
verifying connection quality meets emergency service requirements.

11. The method of claim 8, wherein obtaining the temporary routing number comprises:
identifying available numbers in the pool;
assigning an expiration timestamp to the available numbers; and
updating a pool status.

12. The method of claim 8, wherein selecting the local emergency service provider comprises:
determining jurisdictional boundaries from the coverage areas;
evaluating current provider capacity and capabilities;
checking for service outages or disruptions; and
identifying backup providers if needed.

13. The method of claim 8, wherein transmitting the emergency data comprises:
generating a first data package containing vehicle location and collision severity data;
generating a second data package containing vehicle occupant and hazardous material data;
transmitting the first data package with high priority routing;
transmitting the second data package; and
maintaining connection state between package transmissions.

14. The method of claim 8, further comprising:
assign the temporary routing number an active status for a predetermined time window;
monitor for additional emergency data during the predetermined time window;
append any additional emergency data to an existing connection; and
recycle the temporary routing number only after the predetermined time window expires or the call completes.

15. A non-transitory computer-readable storage medium for tangibly storing computer program instructions capable of being executed by a computer processor, the computer program instructions defining steps of:
receiving emergency data indicating a vehicle requires emergency response;
determining a geographic location of the vehicle;
accessing an emergency services database storing coverage areas for multiple emergency service providers;
selecting a local emergency service provider based on the geographic location;
obtaining a temporary routing number from a pool of emergency routing numbers;
establishing a priority connection to the local emergency service provider using the temporary routing number, the priority connection comprising one or both of a voice or data connection;
transmitting the emergency data via the priority connection;
releasing the temporary routing number back to the pool after a predetermined time period; and
logging connection metrics and routing data.

16. The non-transitory computer-readable storage medium of claim 15, the steps further comprising:
checking fleet preferences before establishing the priority connection;
based on the fleet preferences, either proceeding with one of an automatic connection or requesting manager approval; and
implementing a timeout-based escalation if manager approval is not received within a threshold period.

17. The non-transitory computer-readable storage medium of claim 15, wherein establishing the priority connection comprises:
configuring quality of service parameters for emergency traffic;
implementing packet prioritization protocols; and
verifying connection quality meets emergency service requirements.

18. The non-transitory computer-readable storage medium of claim 15, wherein obtaining the temporary routing number comprises:
identifying available numbers in the pool;
assigning an expiration timestamp to the available numbers; and
updating a pool status.

19. The non-transitory computer-readable storage medium of claim 15, wherein selecting the local emergency service provider comprises:
determining jurisdictional boundaries from the coverage areas;
evaluating current provider capacity and capabilities;
checking for service outages or disruptions; and
identifying backup providers if needed.

20. The non-transitory computer-readable storage medium of claim 15, wherein transmitting the emergency data comprises:
generating a first data package containing vehicle location and collision severity data;
generating a second data package containing vehicle occupant and hazardous material data;
transmitting the first data package with high priority routing;
transmitting the second data package; and
maintaining connection state between package transmissions.
